(19) United States
(12) Patent Application Publication
(10) Pub. No.: US 2020/0298446 A1
(43) Pub. Date: Sep. 24, 2020

(54) PRESTRESSING PROCESS THROUGH PRESTRESSED CONCRETE BARS ACTIVATED FROM THE MIDDLE SECTION OF THE BAR

(71) Applicant: Fernando Rodrigues Gemin, Curitiba (BR)

(72) Inventor: Fernando Rodrigues Gemin, Curitiba (BR)

(21) Appl. No.: 16/899,112

(22) Filed: Jun. 11, 2020

Related U.S. Application Data
(63) Continuation of application No. PCT/BR2018/050455, filed on Dec. 11, 2018.

(30) Foreign Application Priority Data
Dec. 11, 2017 (BR) 20 2017 026689 9

(51) Int. Cl. B28B 23/04; B28B 23/06; B28B 7/34

(52) U.S. Cl. CPC B28B 23/043; B28B 7/342; B28B 23/046; B28B 23/06

(57) ABSTRACT

A process for molding prestressed slender and corrugated surface concrete bars to be used subsequently in casting concrete pieces or structures includes, placing them conveniently inside said pieces or structures, in order to also prestress said pieces or structures by gripping and relieving the tensions contained in said bar from the middle section of its longitudinal length.

### CROSS REFERENCE TO RELATED APPLICATIONS

Continuation of International Application No. PCT/BR2018/050455 filed on Dec. 11, 2018. Priority is claimed from Brazilian Application No. 20 2017 026689 9 filed on Dec. 11, 2017. Both the foregoing applications are incorporated herein by reference in their entirety.

### STATEMENT REGARDING FEDERALLY SPONSORED RESEARCH OF DEVELOPMENT

Not Applicable

### NAMES OF THE PARTIES TO A JOINT RESEARCH AGREEMENT

Not Applicable.

### BACKGROUND

### Field of the Invention

This innovation refers to a prestressing process, more particularly to a prestressing process for pre-cast or molded concrete structures on the work site.

### Background of Innovation and State of the Art

Prestressing processes using pre- and post-tensioned steel wire ropes are already known, having direct application in armed or prestressed concrete pieces or structures.

Regarding the widespread application of the processes currently used, some drawbacks may be pointed out, such as, for example: waste of steel wire ropes or cables, when they are required to be isolated in sections of its longitudinal length, where they have no role whatsoever; the requirement of long tracks for pre-tensioning; use of hydraulic equipment to tension wires in post-tensioning; use restriction for special hard handling pieces such as ladders and L-shaped retaining pieces; unable to prestress separate sections of a concrete piece or structure; and anchoring requirement at bulkheads or ends in case of post-tensioning.

### BRIEF DESCRIPTION OF THE DRAWINGS

FIG. 1 shows a perspective view of a pre-tensioned steel wire cable.

FIG. 2 shows a perspective view of a corrugated surface bar molded around the pre-tensioned steel wire cable.

FIG. 3 shows a perspective view of the corrugated surface bar already prestressed.

FIG. 4 shows a perspective view of a concrete piece or structure molded with the corrugated prestressed surface bar placed inside it.

FIG. 5 shows a perspective view of the aforementioned concrete piece or structure already cured, having an opening for accessing the prestressed bar at the center of its longitudinal length, in order to relieve the tension of the prestressed bar and transfer said tensions to the whole structure or piece, through gripping.

FIG. 6 shows a perspective view of the already prestressed concrete piece or structure, with the aforementioned opening filled out with cement mortar or other material in order to protect the steel shields or wire cables or span wires.

### DETAILED DESCRIPTION

### Description of Technical Problem Approach

In face of the aforementioned disadvantages, and in order to overcome them, this innovation provides a prestressing process by use of prestressed concrete bars, which are activated from the middle section of the bar, which is pre-cast in any size to meet any dimension requirement, overcoming the drawbacks mentioned in the state of the art.

### Detailed Description of the Innovation

This process consists of molding corrugated cylindrical (or any format) bars, prestressed through pre-tensioning of one or more cables. After the concrete is cured, the cable is released from its anchoring and pre-tensioning, thus compressing the pre-cast concrete piece by gripping along its length. Said cylindrical bars are used to cast concrete pieces or structures. After concreting of said pieces or structures, the pre-tensioning of the corrugated bar is relieved, by the center of its longitudinal length, removing a minor section of the corrugated bar without cutting the steel wire ropes or cables which were previously placed there.

Such relief may be carried out in several ways, such as removing a metallic insert concreted to the middle section of the bar around the cables, or with threaded bars using nuts previously concreted with the bar, or whatever else is available; thus transferring by gripping the compression forces trapped in the prestressed bar to the desired piece or structure, so that said piece or structure is prestressed.

The attached drawings show the placement of a cable on the corrugated concrete bar and, afterwards, the same bar inside a structural element, in order to demonstrate the assembly of the bar in a concrete piece or structure.

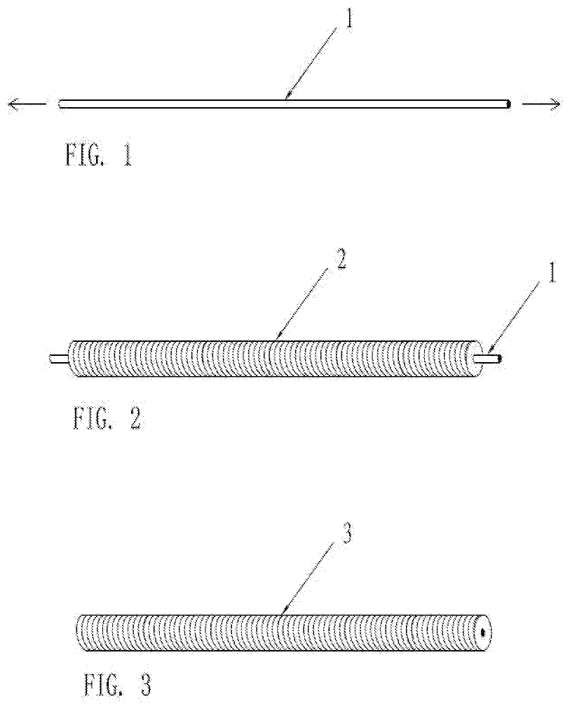

According to the aforementioned figures, the prestressing process through prestressed concrete bars activated from the middle section of a bar, which is the object of this disclosure, comprises molding prestressed corrugated surface bars (FIG. 3); pre-tensioning steel wire ropes, cables or wires (1) (FIG. 1) to traction, and molding a concrete bar (2) which envelops the steel wire rope (1) (FIG. 2) while waiting for proper concrete curing of the bar (2), so that the traction forces on the steel wire rope (1) are transferred to the bar (2) as compression forces, resulting in a prestressed concrete bar 3 (FIG. 3).

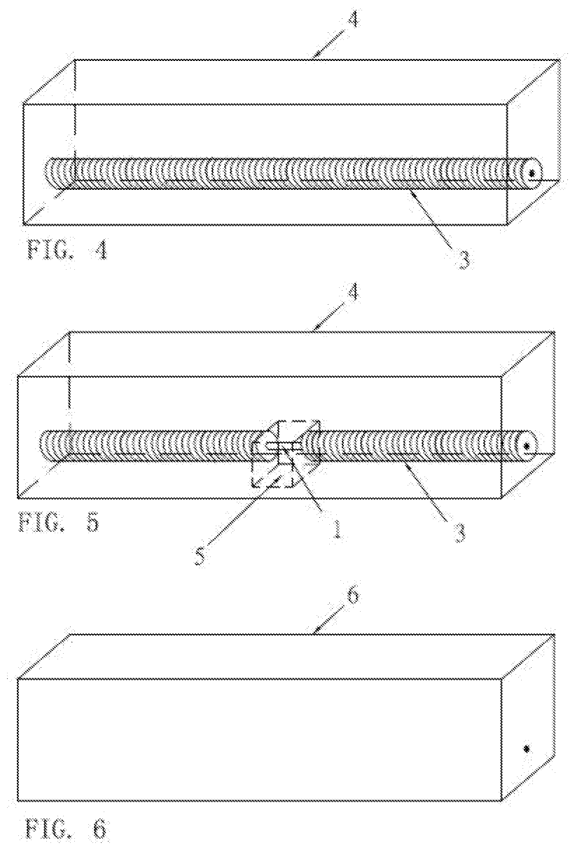

The prestressed concrete bar (3) is used to cast concrete structures or pieces (FIG. 4), conveniently placing the bar (3) within the structure (4).

After sufficient curing of the piece or structure (4) (FIG. 5), a small opening 5 is made to access the middle section of the bar (3), partially exposing the steel wire cable (1), removing the bar material (3) that envelops the steel wire cable (1) in this minor section. After this process, the transfer of compression forces from the bar (3) to the structure (4) takes place.

Lastly, after filling the opening (5) with cement mortar or any other material that protects the cable (1) and other shields that may be present in the structure (4), a prestressed structure or piece (6) is obtained (FIG. 6).

The result is that prestressed bars (FIG. 3) may be produced in numerous lengths and thicknesses, involving one or more steel wire cables (1) to prestress several types of pieces of structures, either mixed or not, with second concrete pouring or otherwise, pre-cast or molded at the work site.

This innovation is not limited to the representations shown or mentioned herein, and must be construed within its wide scope. Many changes and other representations of the invention will occur to a person skilled in the art to which this innovation belongs, with the benefit of the teachings featured in previous descriptions and attached drawings. In addition, the invention is to be understood as non-limiting to the specific form described, and that modifications or other forms are perceived as included in the scope of the attached claims. Although specific terms are featured herein, these are used solely in a generic and descriptive manner, and not as limiting factors.

What is claimed is:

1. A prestressing process through prestressed concrete bars activated from the middle section of the concrete bar, wherein it previously prestresses slender corrugated surface concrete bars (3), said prestressed bars used to cast concrete pieces or structures which shall also be prestressed through transfer of forces by gripping, when said bars (3) are activated from the middle section of its longitudinal length by relieving the tensions previously applied to said prestressed bar, removing part of the cast concrete around the steel wire cable (1) placed inside the prestressed bar (3) or using any other device previously introduced to the center of the bar capable of relieving said tensions, transferring them to the concrete piece or structure.

2. A method for prestressing cast concrete structures, comprising:
casting a concrete bar, the cast concrete bar having corrugations on its exterior surface, the concrete bar cast externally to a tensioned cable;
releasing the cable from tension;
casing a concrete structure externally to the concrete bar;
creating an opening in the concrete structure to access the concrete bar proximate a center of the concrete bar removing a section of the concrete bar proximate a center thereof; and
filling the opening with a material to protect the cable.

3. The method of claim 2 wherein the material comprises cement mortar.

4. The method of claim 2 wherein the concrete bar is cylindrical.
